(19) United States
(12) Patent Application Publication
(10) Pub. No.: US 2019/0221802 A1
(43) Pub. Date: Jul. 18, 2019

(54) POLYMER-BASED BATTERY ENCLOSURE WITH VENT MANIFOLD

(71) Applicant: Ford Global Technologies, LLC, Dearborn, MI (US)

(72) Inventors: Patrick Daniel Maguire, Ann Arbor, MI (US); Kyle Krueger, Dearborn, MI (US); Mohammadreza Eftekhari, Northville, MI (US)

(21) Appl. No.: 15/872,302

(22) Filed: Jan. 16, 2018

(51) Int. Cl. H01M 2/12; H01M 2/10

(52) U.S. Cl. CPC H01M 2/1229; H01M 2220/20; H01M 2/1077

(57) ABSTRACT

An exemplary battery assembly includes, among other things, a battery array, and an expanded polymer-based enclosure that at least partially surrounds the battery array. The expanded polymer-based enclosure includes a vent manifold to communicate gases vented from the battery array. An exemplary method includes, among other things, forming a vent manifold within a polymer-based enclosure. The vent manifold is to communicate gases vented from a battery array. The method further includes at least partially surrounding the battery array with the polymer-based enclosure.

### TECHNICAL FIELD

This disclosure relates generally to a battery pack of an electrified vehicle. In particular, the disclosure relates to a battery enclosure that includes a vent manifold for discharging gases during battery cell venting events.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine. Example electrified vehicles include hybrid electric vehicles (HEVs), plug-in hybrid electric vehicles (PHEVs), fuel cell vehicles (FCVs), and battery electric vehicles (BEVs).

The traction battery is a relatively high-voltage battery that selectively powers the electric machines and other electrical loads of the electrified vehicle. The traction battery can include battery arrays each including a plurality of interconnected battery cells that store energy. Some electrified vehicles, such as PHEVs, can charge the traction battery from an external power source.

Gas is a battery vent byproduct that can be expelled from the battery cells under certain conditions. The gas can be at a high pressure and high temperature. The gas may need to be purged from the traction battery.

### SUMMARY

A battery assembly according to an exemplary aspect of the present disclosure includes, among other things, a battery array, and an expanded polymer-based enclosure that at least partially surrounds the battery array. The expanded polymer-based enclosure includes a vent manifold to communicate gases vented from the battery array.

In a further non-limiting embodiment of the foregoing assembly, the expanded polymer-based enclosure is made of polypropylene.

In a further non-limiting embodiment of any of the foregoing assemblies, the vent manifold includes a chamber within the expanded polymer-based enclosure. The chamber is disposed directly over a vent of a battery cell within the battery array.

A further non-limiting embodiment of any of the foregoing assemblies includes a protective lining that lines an area of the chamber. The protective lining protects areas of the expanded polymer-based enclosure from gases vented from the vent.

In a further non-limiting embodiment of any of the foregoing assemblies, the protective lining is a metal or metal-alloy layer.

In a further non-limiting embodiment of any of the foregoing assemblies, the protective lining is an area of the expanded polymer-based enclosure that has a higher density than other areas of the expanded polymer-based enclosure.

In a further non-limiting embodiment of any of the foregoing assemblies, the vent manifold includes a conduit within the expanded polymer-based enclosure. The conduit opens to an aperture in a frame of a vehicle.

A further non-limiting embodiment of any of the foregoing assemblies includes a gasket within the conduit. The gasket is configured to rupture in response to gases vented through the vent to permit the gases to pass from the conduit through the aperture to an area outside the vehicle.

In a further non-limiting embodiment of any of the foregoing assemblies, a perimeter of an axial section through the conduit is defined entirely by the expanded polymer-based enclosure.

In a further non-limiting embodiment of any of the foregoing assemblies, the expanded polymer-based enclosure is a tray of a battery pack enclosure.

In a further non-limiting embodiment of any of the foregoing assemblies, the vent manifold further includes a chamber within a midcover of the expanded polymer-based enclosure. The chamber is disposed directly over the vent. The chamber is in fluid communication with the conduit within the tray.

A method according to an exemplary aspect of the present disclosure includes, among other things, forming a vent manifold within a polymer-based enclosure. The vent manifold is to communicate gases vented from a battery array. The method further includes at least partially surrounding the battery array with the polymer-based enclosure.

In a further non-limiting embodiment of the foregoing method, the polymer-based enclosure is an expanded polymer.

In a further non-limiting embodiment of any of the foregoing methods, the vent manifold includes a chamber within the polymer-based enclosure. The chamber is disposed directly over the vent.

A further non-limiting embodiment of any of the foregoing methods includes lining an area of the chamber with a protective lining that protects the polymer-based enclosure from gases vented from the vent.

In a further non-limiting embodiment of any of the foregoing methods, the vent manifold includes a conduit within the polymer-based enclosure. The conduit opens to an aperture within a frame of a vehicle.

A further non-limiting embodiment of any of the foregoing methods includes rupturing a gasket disposed within the conduit to permit gases to move through the column, and through the aperture to an area outside of the vehicle.

In a further non-limiting embodiment of any of the foregoing methods, at a given axial section through the conduit, a perimeter of the conduit is provided entirely by the polymer-based enclosure.

A further non-limiting embodiment of any of the foregoing methods includes communicating gases from the vent, through a chamber within the polymer-based enclosure, and to the conduit.

In a further non-limiting embodiment of any of the foregoing methods, the chamber is within a midcover of the polymer-based enclosure and the conduit is within a tray of the polymer-based enclosure.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 schematically illustrates a powertrain of an electrified vehicle.

FIG. 2 illustrates a battery pack from the powertrain of FIG. 1.

FIG. 3 illustrates an expanded view of selected portions of the battery pack of FIG. 2.

FIG. 4 illustrates a schematic view of selected portions of a vent manifold provided by the enclosure of the battery pack of FIG. 2.

FIG. 5 illustrates a top view of a midcover of an enclosure of the battery pack of FIG. 2.

FIG. 6 illustrates a bottom view of the midcover of FIG. 4.

FIG. 7 illustrates a section view taken at line 7-7 in FIG. 2.

FIG. 8 illustrates a section view taken at line 8-8 in FIG. 2.

FIG. 9 illustrates a section view taken at line 9-9 in FIG. 3.

### DETAILED DESCRIPTION

This disclosure describes a battery pack for an electrified vehicle. The battery pack includes an enclosure that is polymer-based. The enclosure houses arrays of battery cells. One or more of the battery cells can occasionally release gases during a battery venting event.

A vent manifold of the enclosure can communicate the gases away from the battery cells. The vent manifold communicates the gases from an interior of the battery pack to an exterior of the battery pack and, potentially, to an exterior of a vehicle having the battery pack. These and other features are discussed in greater detail in the following paragraphs of the detailed description.

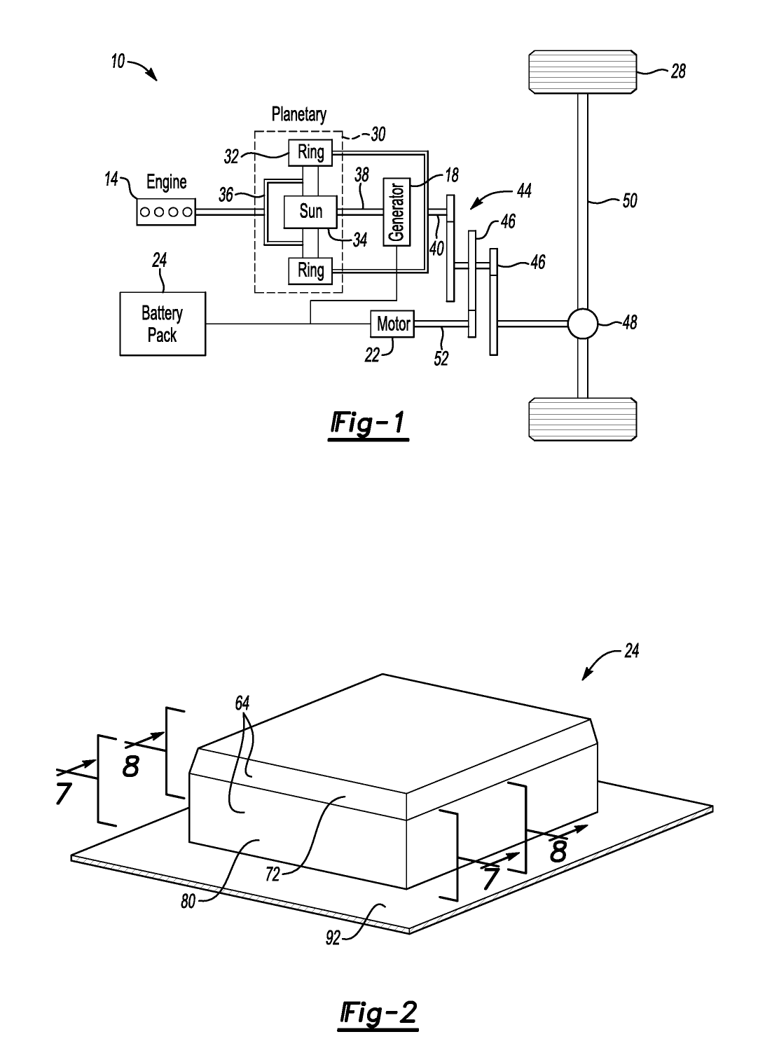

FIG. 1 schematically illustrates a powertrain 10 for an electrified vehicle. In an embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle.

The engine 14, which is an internal combustion engine in this example, and the generator 18 may be connected through a power transfer unit 30. In one non-limiting embodiment, the power transfer unit 30 is a planetary gear set that includes a ring gear 32, a sun gear 34, and a carrier assembly 36. Of course, other types of power transfer units, including other gear sets and transmissions, may be used to connect the engine 14 to the generator 18.

The generator 18 can be driven by engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In this example, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an example type of electrified vehicle battery assembly. The battery pack 24 may have the form of a high-voltage battery that is capable of outputting electrical power to operate the motor 22 and the generator 18. Other types of energy storage devices and/or output devices can also be used with the electrified vehicle having the powertrain 10. The battery pack 24 is a traction battery pack as the battery pack 24 can provides power to propel the wheels 28.

Although depicted as a powertrain for a hybrid electrified vehicle (HEV), it should be understood that the concepts described herein are not limited to HEVs and could extend to other electrified vehicles, including, but not limited to, plug-in hybrid electrified vehicles (PHEVs), fuel cell vehicles, and battery electrified vehicles (BEVs).

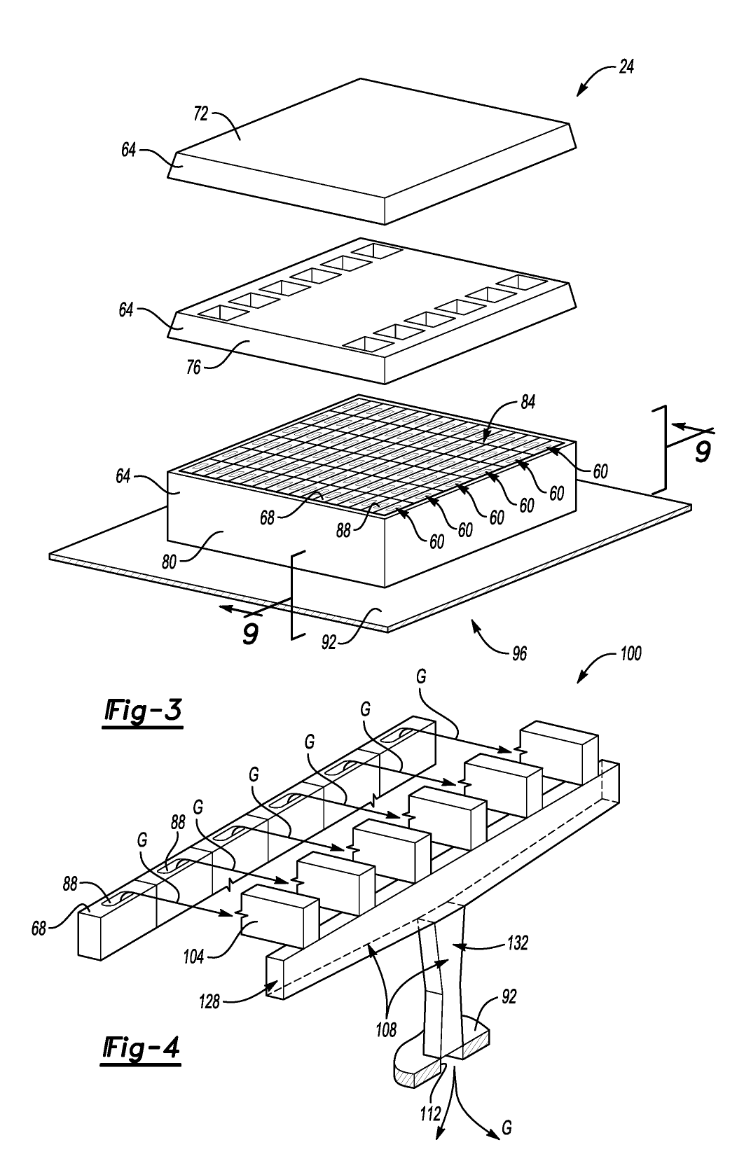

With reference now to FIGS. 2 and 3, the battery pack 24 includes a plurality of battery arrays 60 held within an enclosure 64. The battery arrays 60 each include a plurality of individual battery cells 68. The battery cells 68 are capable of outputting electrical power to operate the motor 22, the generator 18, and/or other electrical loads of the electrified vehicle. Other types of energy storage devices could be used instead of, or in addition to, the battery pack 24 to electrically power the electrified vehicle.

Within the arrays 60, the battery cells 68 can be stacked side-by-side along a longitudinal axis or on top of one another to construct the individual arrays 60, which are sometimes referred to as “cell stacks.” The battery pack 24, in the exemplary embodiment, includes six arrays 60 within the enclosure 64. The specific number of battery cells 68 within each of the arrays 60 can vary and still fall within the scope of this disclosure. In other words, this disclosure is not limited to the specific configuration of arrays 60 and battery cells 68 shown in FIGS. 2 and 3.

In one non-limiting embodiment, the battery cells 68 are prismatic, lithium-ion cells. However, battery cells having other geometries (cylindrical, pouch, etc.), other chemistries (nickel-metal hydride, led-acid, etc.), or both, could alternatively be utilized within the scope of this disclosure. The battery cells 68 can be held within the arrays 60 utilizing various other support structures (e.g., spacers, rails, plates, etc.). For drawing clarity, these other support structures are not shown in the Figures.

The enclosure 64, in the exemplary embodiment, includes a lid 72, a midcover 76, and a tray 80. The lid 72, the midcover 76, and the tray 80 each at least partially surround the arrays 60.

In the exemplary embodiment, the tray 80 provides an open area 84 to hold the arrays 60. The midcover 76 nests within the lid 72. The midcover 76 and the lid 72 are secured relative to the tray 80 to enclose the battery arrays 60 within the open area 84. The enclosure 64 could have other configurations in other examples. For instance, the midcover 76, the lid 72, or both could provide some of the open area 84.

Further, in other examples, the enclosure 64 could enclose the open area 84 with only one of the lid 72 or the midcover 76. That is, the enclosure 64 could omit the lid 72 or the midcover 76 in some examples.

Other structures of the battery pack 24 could be held within the open area 84 in addition to the battery arrays 60. Other structures could include electronic components, busbar assemblies, etc. The structures are not shown in the Figures for drawing clarity.

In this example, the midcover 76 and the tray 80 are molded of an expanded polymer-based material, and the lid 72 is molded of a solid polymer-based material. In another example, the lid 72 is also molded from an expanded polymer-based material.

Exemplary expanded polymer-based materials can include expanded polypropylene, expanded polystyrene, and expanded polyethylene. Generally, these polymer-based materials are considered relatively rigid foamed polymer-based materials. In another example, the midcover 76 and the tray 80 are molded from a non-foamed polymer-based material.

The battery cells 68 each includes one or more vents 88. During operation, the vents 88 are ordinarily closed. From time to time, however, the vents 88 can rupture, or otherwise open, to permit gases and other battery vent byproducts, to be expelled from within the respective battery cells 68. Gases expand within the battery cells 68, and the pressure of these gases ruptures the vents 88 to permit the gases to escape from the interiors of the battery cells 68. The battery cells 68 may require expulsion of the battery vent byproducts if the battery cells 68 become overheated or overcharged.

The enclosure 64 includes molded-in features to facilitate communicating gases vented from the battery cells 68 to an exterior of the battery pack 24. Other venting systems typically require many other structures separate from the enclosure 64 to expel battery vent byproducts. These other structures can include tubes, seals, fittings, manifolds, etc., and can add complexity and cost.

In this example, the battery pack 24 is disposed on a vehicle frame 92 within an interior of the vehicle. The molded-in features within the enclosure 64 direct gases vented from the battery cells 68 through an aperture in the vehicle frame 92 to an exterior 96 of the vehicle. The gases can then disperse to the environment surrounding the vehicle.

Referring to the schematic of FIG. 4 with continuing reference to FIGS. 2 and 3, the features within the enclosure 64 provide a vent manifold 100. In this example, the midcover 76 includes a plurality of molded-in chambers 104 that provide a portion of the vent manifold 100. The chambers 104 are truncated in FIG. 4. The tray 80 then includes a molded-in conduit 108 that provides another portion of the vent manifold 100.

Gases G vented from the battery cells 68 can pass from the vents 88 into a respective one of the chambers 104. The gases G then move to the conduit 108. From the conduit 108, the gases pass through an aperture 112 in the vehicle frame 92 to an environment outside the vehicle. For illustrative purposes, gases G are shown in FIG. 4 venting from six of the battery cells 68. In operation, gases G could vent from only one of the battery cells 68, or from some other number of battery cells within the battery pack 24.

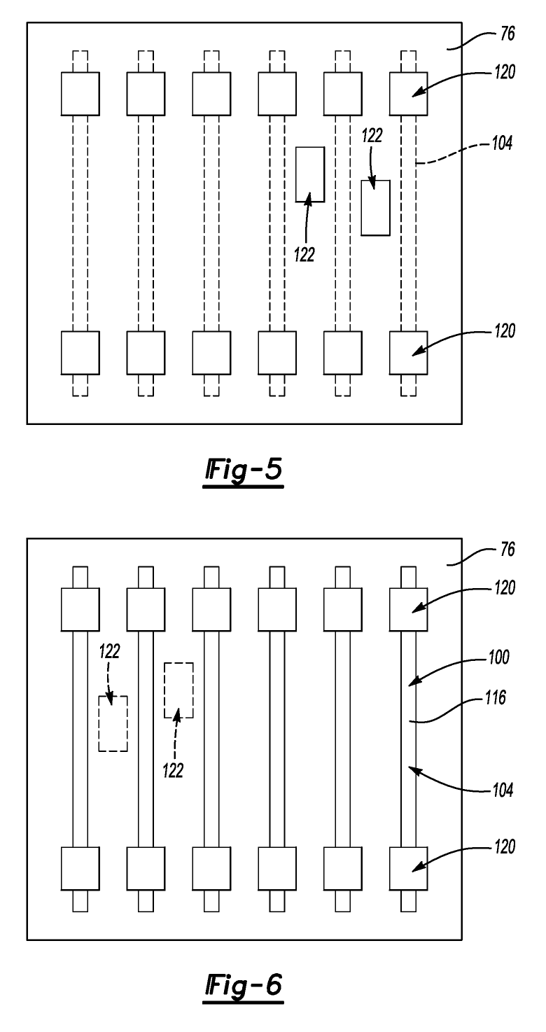

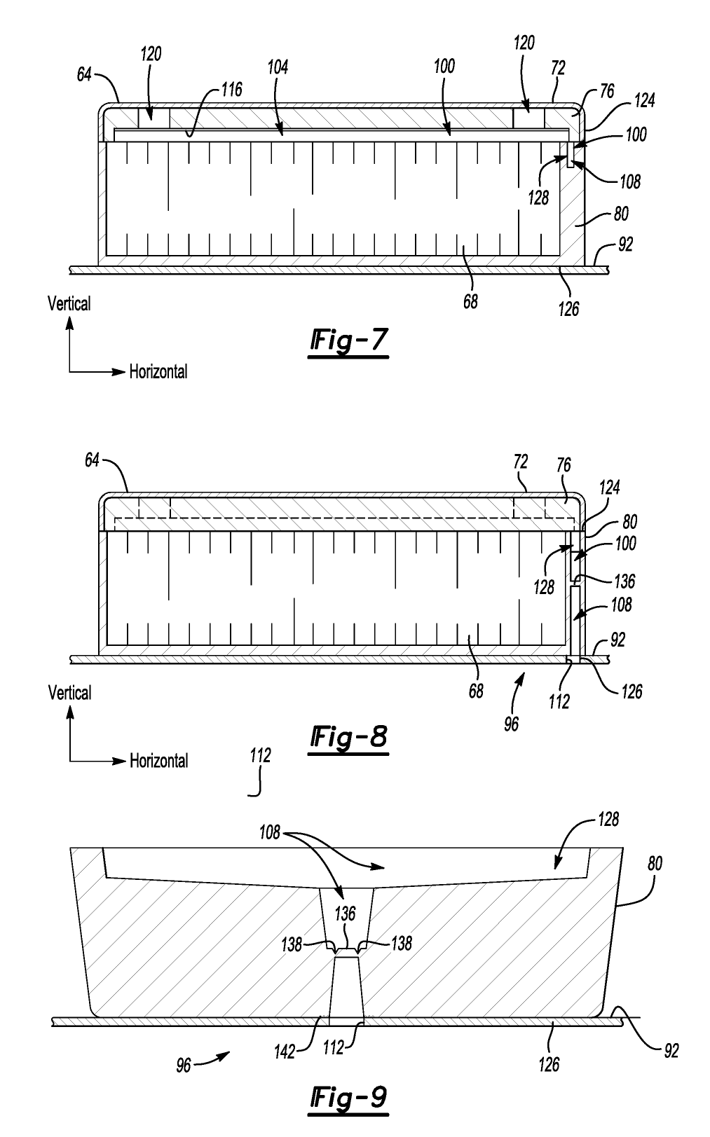

With reference now to FIGS. 5-9 and continuing reference to FIGS. 3 and 4, the example midcover 76 includes six chambers 104. The chambers 104 are each disposed directly over vents 88 of battery cells 68 within one of the arrays 60. Each of the chambers 104 is associated with one of the arrays 60. Gases vented from the battery cells 68 can pass directly into one of the chambers 104.

In some examples, areas of the chambers 104 are lined with a protective lining 116. The protective lining 116 can be positioned in the areas most likely to interface with gases expelled from the vents 88 into the chambers 104. The gases from the vents 88 can impinge on the surfaces of the midcover 76 providing the chambers 104. These higher pressure gases can be relatively hot. The protective lining 116 can protect the midcover 76 as gases are expelled from the battery cells 68 into the chamber.

The protective lining 116 can be, for example, a layer of metal or metal alloy lining selected portions of the chambers 104. The layer of metal or metal alloy can be inmolded with the midcover 76. In another example, the protective lining is an area of the midcover 76 having a material composition differing from a material composition of the remaining portions of the midcover 76. For example, the protective lining 116 could be an area of the midcover 76 having a higher density expanded polymer than other areas of the protective lining 116.

Some areas of the chambers 104 pass entirely through the midcover 76 to provide chamber clearance openings 120. During assembly of the battery pack 24, the chamber clearance openings 120 can provide access to connect various battery pack components to the battery cells 68. For example, electrical leads, busbar connectors, electrical connectors, and other battery pack components may connect directly to the battery cells 68 and pass through the clearance openings 120. A user assembling the battery pack 24 can make these connections via the clearance openings 120 prior to placing the lid 72 over the midcover 76. The midcover 76 can include molded-in pockets 122 that house these battery pack components.

Again, although the example chamber 104 is molded into the midcover 76, other examples could mold the chamber into other components of the enclosure 64. For example, the midcover 76 could be omitted, and the chamber 104 molded into the lid 72.

The conduit 108 is molded into the tray 80 and extends from a vertical top 124 of the tray 80 to a vertical bottom 126 of the tray 80. The example conduit 108 has an axial section with a perimeter that is provided entirely by the tray 80. The vertical bottom 126 of the tray 80 rests adjacent the vehicle frame 92. For purposes of this disclosure vertical is with reference to ground and the normal orientation of the battery pack 24 and vehicle during operation.

The conduit 108 includes a combining portion 128 that can receive gases directly from each of the chambers 104. A columnar portion 132 of the conduit 108 extends vertically downward from the combining portion 128 to a position adjacent the aperture 112 within the vehicle frame 92.

In this example, a gasket 136 is molded within the tray 80 to span across the columnar portion 132. The gasket 136 seals the vent manifold 100 from the exterior 96 of the vehicle when the vent manifold 100 is not venting gases from the battery cells 68. The gasket 136 can block contaminants from passing from the exterior 96 back through the columnar portion 132 into the battery pack 24. The columnar portion 132 initially tapers downward from the combining portion 128 to the gasket and then outward to the vertical bottom 126 of the tray 80. The tapering can provide draw angles that facilitate molding the conduit 108 within the tray 80.

The example gasket 136 is disposed vertically about midway up the columnar portion 132, which can help to avoid an object, such as a person's finger, entering the aperture 112 and rupturing the gasket 136 during handling. Additionally, because the columnar portion 132 can be tapered, placing the gasket 136 vertically upward within the columnar portion 132 can provide the gasket 136 with a lower rupture threshold as there is more area of the gasket 136 for the pressure of the gas to act on.

In another example, the gasket 136 is vertically positioned directly adjacent the aperture 112.

Pressure within the vent manifold 100 increases when gases are vented from the battery cells 68. The pressure can cause the gasket 136 to rupture and permit the gases to pass through the columnar portion 132 to the exterior 96. The gasket 136 can be molded with tear lines 138 that facilitate a controlled rupture of the gasket 136. The gasket 136 can be considered a blow-out gasket, in some examples.

Near the aperture 112 in the vehicle frame 92, at the vertical bottom 126 of the tray 80, the tray 80 is molded to include one or more ribs 142. The ribs 142 can extend circumferentially about the aperture 112. The ribs 142 provide a double ring about the aperture 112 in this example.

The ribs 142 are press-fit against the vehicle frame 92 to seal the interface between the tray 80 and the vehicle frame 92. Sealing this interface can block gases from passing between a surface of the tray 80 and the vehicle frame 92. The ribs 142 help to ensure that the gases are directed from the columnar portion 132 through the aperture 112 to the exterior 96 of the vehicle.

In this example, a diameter of the aperture 112 is about the same as a diameter of the opening to the columnar portion 132 at the vertical bottom 126 of the tray 80. In other examples, a diameter of the aperture 112 could be reduced relative to the opening to the columnar portion 132 at the vertical bottom 126 of the tray 80. Reducing a size of the aperture 112 could help to accommodate some assembly variability when positioning the opening to the columnar portion 132 over the aperture 112. That is, the aperture 112 could have some radial offset relative to the columnar portion 132 and still provide a pathway for the gas to move from the columnar portion 132 through the aperture 112 while also providing adequate areas for the ribs 142 to press-fit against the vehicle frame 92.

Although the example battery pack 24 is disclosed as including an enclosure with a molded-in vent manifold that communicates vented gases from the traction battery pack to the exterior 96 of the vehicle, the battery pack 24 is not limited to such a configuration. In another example, the battery pack 24 could be mounted to the exterior 96 of the vehicle, and the vent manifold configured to communicate gases from an interior of the battery pack to the exterior 96 of the battery pack without passing through an aperture in a vehicle frame.

Further, in this example, the midcover 76 provides the chambers 104 as a portion of the vent manifold 100. In another example, the chambers 104 are omitted and the molded-in conduit 108 is configured to receive the gas without from an area between the lid 72 and the tray 80. That is, the molded-in portion of the vent manifold 100 could be provided entirely by the tray 80.

Features of the disclosed examples include an enclosure molded to include a dedicated vent manifold within an enclosure of a battery pack. The vent manifold is provided without substantial extra structures, such as tubes, clamps, seals, fittings, or gasket components. The vent manifold is thus provided without substantially increasing part, assembly complexity, weight, etc.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A battery assembly, comprising:
a battery array; and
an expanded polymer-based enclosure that at least partially surrounds the battery array and includes a vent manifold to communicate gases vented from the battery array.

2. The assembly of claim 1, wherein the expanded polymer-based enclosure is made of polypropylene.

3. The assembly of claim 1, wherein the vent manifold includes a chamber within the expanded polymer-based enclosure, the chamber disposed directly over a vent of a battery cell within the battery array.

4. The assembly of claim 3, further comprising a protective lining that lines an area of the chamber, the protective lining protecting areas of the expanded polymer-based enclosure from gases vented from the vent.

5. The assembly of claim 4, wherein the protective lining is a metal or metal-alloy layer.

6. The assembly of claim 4, wherein the protective lining is an area of the expanded polymer-based enclosure that has a higher density than other areas of the expanded polymer-based enclosure.

7. The assembly of claim 1, wherein the vent manifold includes a conduit within the expanded polymer-based enclosure, the conduit opening to an aperture in a frame of a vehicle.

8. The assembly of claim 7, further comprising a gasket within the conduit, the gasket configured to rupture in response to gases vented through the vent to permit the gases to pass from the conduit through the aperture to an area outside the vehicle.

9. The assembly of claim 7, wherein a perimeter of an axial section through the conduit is defined entirely by the expanded polymer-based enclosure.

10. The assembly of claim 7, wherein the expanded polymer-based enclosure is a tray of a battery pack enclosure.

11. The assembly of claim 10, wherein the vent manifold further comprises a chamber within a midcover of the expanded polymer-based enclosure, the chamber disposed directly over the vent, the chamber in fluid communication with the conduit within the tray.

12. A method, comprising:
forming a vent manifold within a polymer-based enclosure, the vent manifold to communicate gases vented from a battery array; and
at least partially surrounding the battery array with the polymer-based enclosure.

13. The method of claim 12, wherein the polymer-based enclosure is an expanded polymer.

14. The method of claim 12, wherein the vent manifold includes a chamber within the polymer-based enclosure, the chamber disposed directly over the vent.

15. The method of claim 14, further comprising lining an area of the chamber with a protective lining that protects the polymer-based enclosure from gases vented from the vent.

16. The method of claim 12, wherein the vent manifold includes a conduit within the polymer-based enclosure, the conduit opening to an aperture within a frame of a vehicle.

17. The method of claim 16, further comprising rupturing a gasket disposed within the conduit to permit gases to move through the column, and through the aperture to an area outside of the vehicle.

18. The method of claim 16, wherein at a given axial section through the conduit, a perimeter of the conduit is provided entirely by the polymer-based enclosure.

19. The method of claim 16, further comprising communicating gases from the vent, through a chamber within the polymer-based enclosure, and to the conduit.

20. The method of claim 19, wherein the chamber is within a midcover of the polymer-based enclosure and the conduit is within a tray of the polymer-based enclosure.
